(19) United States
(12) Patent Application Publication
(10) Pub. No.: US 2026/0229797 A1
(43) Pub. Date: Aug. 6, 2026

(54) GROUND DEVICES, SYSTEMS, AND METHODS OF USE

(71) Applicant: MW LINEMAN TOOLS, LLC, Birmingham, AL (US)

(72) Inventor: Larry McHenry, San Antonio, TX (US)

(21) Appl. No.: 19/044,622

(22) Filed: Feb. 3, 2025

(51) Int. Cl. H01R 4/66; H01R 4/48; H02B 5/00

(52) U.S. Cl. CPC H01R 4/66; H01R 4/4854; H02B 5/00

(57) ABSTRACT

A ground device and related methods and systems prevent electrocution of a line worker while replacing distribution transformers. The ground device directly or indirectly connects to the secondary lines to discharge the hot line and prevent back-feed-caused electrocution. Multiple electrically collected clamps form the connections with the secondaries to shunt the back feed.

### FIELD OF THE INVENTION

The present technology is in the field of power generation protection and, more specifically, related to protecting a utility worker from being injured from back feed while performing a distribution transformer replacement.

### BACKGROUND

Devices like solar panels and generators can provide power from the consumer endpoints of the power grid. While utility workers perform operations on a deenergized commercial power generation grid, a danger to workers is a customer back feeding power into the grid from a customer's power source. This back feeding of power into the commercial grid can cause serious injury to line workers and other utility workers including life threatening injuries.

In residential areas, the power grid contains pole-mounted or underground high voltage lines and a primary neutral. A typical power delivery system to a residence uses a distribution transformer that steps down a high voltage from the primary lines (thousands of volts) into a lower voltage of secondary power lines (110V per line typically in the USA). These secondary power lines connect the distribution transformer to the residence and typically include a powered line L1, a powered line L2, and a neutral line N. While replacing a distribution transformer, a line worker will typically disconnect deenergized lines L1, L2, and N from the side terminals of the distribution transformer and then position these lines aside to work on the transformer itself. In the unfortunate situation of back feed current from the consumer side while a line worker's body inadvertently electrically contacts lines L1, L2, or N while removing the old distribution transformer or mounting a new distribution transformer, death by electrocution may result. Several line workers have lost their lives in this exact situation.

With the increasing frequency and intensity of natural disasters, homeowners are preparing for natural disasters by purchasing generators to provide electricity during natural disasters. As such, increasing instances of back feeding are an ever-increasing risk to the life of line workers.

There are some ground devices used in the power grid industry, such as those used when isolating a section of high voltage power lines or 2-clamp jumper cables used while installing an arrestor or insulator upstream from the transformer. However, these ground devices are inadequate or less desirable for the purposes described herein.

### SUMMARY

The disclosure provides support for a ground device, comprising: at least one shunt, three clamps that are electrically connected by the at least one shunt that defines an electrically conductive path extending to all of the clamps, the clamps sized to attach to secondary lines that connect to secondary terminals of a distribution transformer, and the clamps and conductor physically capable of carrying current flows such that electrical current applied to one clamp of higher electrical potential flows along the conductor to at least one other clamp of lower electrical potential of the three clamps, wherein when some or all of the three clamps are attached individually to the secondary lines, back feed electrical current through one of the secondary lines is diverted to at least one of the other secondary lines. In a first example of the system, each of three clamps are hand actuated with a spring that applies tension to insulating handles of the three clamps capable of preventing or minimizing electrical shock from energized secondary lines and compression on conductive jaws of the three clamps in electrical contact with the at least one shunt. In a second example of the system, optionally including the first example, each of three clamps are able to remain secured to the respective secondary line even when that secondary line has been detached from the secondary terminals. In a third example of the system, optionally including one or both of the first and second examples, the at least one shunt comprises a shunt between a neutral clamp and a power clamp of the three clamps, and a shunt between the neutral clamp and another power clamp of the three clamps. In a fourth example of the system, optionally including one or more or each of the first through third examples, jaws of the three clamps are electrically connected to the at least one shunt by a braided copper bonding strap. In a fifth example of the system, optionally including one or more or each of the first through fourth examples, the ground device is designed to maintain current flow until another component in electrical connection with a secondary line fails, trips, or engages over current protection. In a sixth example of the system, optionally including one or more or each of the first through fifth examples, the at least one shunt is an insulated copper wire with a Thermoplastic High Heat-Resistant Nylon jacket. In a seventh example of the system, optionally including one or more or each of the first through sixth examples, the at least one shunt has an ampacity of at least 100 A and class K stranding. In a eighth example of the system, optionally including one or more or each of the first through seventh examples, the three clamps include two power clamps and a neutral clamp, wherein the neutral clamp is the central clamp of the three clamps. In a ninth example of the system, optionally including one or more or each of the first through eighth examples, at least one of the one or more shunt elements has a low impedance. In a tenth example of the system, optionally including one or more or each of the first through ninth examples, the insulating handles of at least one of the three clamps includes PVC insulation. In a eleventh example of the system, optionally including one or more or each of the first through tenth examples, at least one shunt has a lug crimped on to at least one connection of the shunt, wherein a clamp of the three clamps corresponding to the connection end the shunt contains at least one threaded stud to receive the lug, and wherein the at least one shunt is connected to the clamp using the threaded stud and a nut. In a twelfth example of the system, optionally including one or more or each of the first through eleventh examples, a length, stiffness, and/or preorientation of the at least one shunt between each clamp prevents any of the three clamps from making contact with each other without an external physical force pushing them together. In a thirteenth example of the system, optionally including one or more or each of the first through twelfth examples, at least one of the three clamps has an insulated ring connected to a handle of the clamp. In a fourteenth example of the system, optionally including one or more or each of the first through thirteenth examples, the system further comprises: a fourth clamp directly electrically connected to the middle of the three clamps. In a fifteenth example of the system, optionally including one or more or each of the first through fourteenth examples, a central clamp of the three clamps is color coded and/or marked to contrast with other clamps of the three clamps as a neutral clamp.

The disclosure also provides support for a method of replacing a distribution transformer, the method comprising: attaching a neutral clamp of a ground device to a neutral secondary line such that the clamped neutral secondary lines may be removed from the distribution transformer without disconnecting the neutral clamp, attaching two power line clamps of the ground device to two power secondary lines such that the two clamped power secondary lines may be removed from the distribution transformer without disconnecting the two power clamps, removing the clamped neutral line and clamped power secondary lines from the distribution transformer, replacing the distribution transformer with a new distribution transformer, connecting the clamped secondary lines to the new distribution transformer, removing the two power line clamps from the two or more power lines of the secondary lines, and removing the neutral clamp from one or more neutral lines of the secondary lines. In a first example of the method, clamped secondary lines are reattached to the new distribution transformer while maintaining connection with the ground device. In a second example of the method, optionally including the first example, the method further comprises: additional steps of attaching a primary neutral line clamp of the ground device to a primary neutral line of the distribution transformer, and removing the primary neutral line clamp from the primary neutral line of the new distribution transformer. In a third example of the method, optionally including one or both of the first and second examples, the method further comprises: additional steps of attaching a third power line clamp of the ground device to a third power secondary line of the distribution transformer, and removing the third power clamp from the third power secondary line of the new distribution transformer. In a fourth example of the method, optionally including one or more or each of the first through third examples, before attaching any or each of the clamps, confirming that the electricity is not present in any of the secondary lines. In a fifth example of the method, optionally including one or more or each of the first through fourth examples, the step of attaching the neutral clamp further comprises attaching a primary ground clamp separate from the neutral clamp to primary ground, and removing one or more neutral clamps further comprises removing the primary ground clamp. The disclosure also provides support for each part of the process clamping the neutral clamp to the neutral secondary line clamping a neutral clamp of a ground device to a neutral secondary line such that the clamped neutral secondary lines may be removed from the distribution transformer without disconnecting the neutral clamp; clamping two power line clamps of the ground device to two power secondary lines such that the two clamped power secondary lines may be removed from the distribution transformer without disconnecting the two power clamps; and removing the clamped neutral line and clamped power secondary lines from the distribution transformer. The disclosure also provides support for. connecting the clamped secondary lines to the new distribution transformer; removing the two power line clamps from the two or more power lines of the secondary lines; and removing the neutral clamp from one or more neutral lines of the secondary lines.

The disclosure also provides support for a system, wherein the system comprises: a distribution transformer with secondary terminals, and three secondary lines that connect to the secondary terminals, a ground device with three clamps electrically connected by at least one shunt, with each clamp connected to each of the three secondary lines, wherein when any of the secondary lines becomes energized from back feed, the ground device discharges the back feed from the energized secondary line to at least one other of the secondary lines. In a first example of the system, the system further comprises a device designed to stop the back feed upon receiving the discharge current from the at least one other of the secondary lines: The system of claim 23, wherein the device designed to stop the back feed is a circuit breaker and/or a fault interrupter.

The disclosure provides support for a ground device, consisting of: at least one shunt, three clamps that are electrically connected by the at least one shunt that defines an electrically conductive path extending to all of the clamps, the clamps sized to attach to secondary lines that connect to secondary terminals of a distribution transformer, and the clamps and conductor physically capable of carrying current flows such that electrical current applied to one clamp of higher electrical potential flows along the conductor to at least one other clamp of lower electrical potential of the three clamps, wherein when some or all of the three clamps are attached individually to the secondary lines, back feed electrical current through one of the secondary lines is diverted to at least one of the other secondary lines.

The disclosure provides support for a ground device, consisting essentially of: at least one shunt, three clamps that are electrically connected by the at least one shunt that defines an electrically conductive path extending to all of the clamps, the clamps sized to attach to secondary lines that connect to secondary terminals of a distribution transformer, and the clamps and conductor physically capable of carrying current flows such that electrical current applied to one clamp of higher electrical potential flows along the conductor to at least one other clamp of lower electrical potential of the three clamps, wherein when some or all of the three clamps are attached individually to the secondary lines, back feed electrical current through one of the secondary lines is diverted to at least one of the other secondary lines.

### BRIEF DESCRIPTION OF THE DRAWINGS

In order to more fully understand this specification, reference is made to the accompanying drawings or figures. The examples are described in accordance with the aspects and embodiments in the following description with reference to the drawings or figures (FIG.), in which like numbers represent the same or similar elements. To simplify the drawings, a reference numeral may not be repeatedly displayed in subsequent drawings for the same or similar element, but the reader should understand that such element is present even though the reference numeral has not been repeated. Understanding that these drawings are not to be considered limitations in the scope of the invention, the presently described aspects and embodiments and the presently understood best mode of the invention are described with additional detail through use of the accompanying drawings. The drawings are not to scale unless otherwise noted. For convenience, the same reference numerals may be used across the drawing set to represent the same or similar items.

FIG. 1 depicts an overview of a power-grid-to-residential power delivery system in normal operation.

FIG. 2A depicts a block diagram of an example grounding system connected to the secondary lines of the power-grid-to-residential power delivery system of FIG. 1.

FIG. 2B depicts the block diagram of FIG. 2A where the example ground device is connected to an alternative location of the secondary wire lugs of the secondary terminals of the transformer.

FIG. 3A is a block diagram of an example implementation of a 3-clamp ground device.

FIG. 3B is a diagram of the example device of FIG. 3A where the ground device is visualized with graphics of the clamps and shunts.

FIG. 3C is a second example of a ground device of FIG. 3B with an additional clamp and shunt used for contact with the primary neutral.

FIG. 3D is a third example of a ground device of FIG. 3B with an additional clamp and shunt used for contact with an additional secondary line.

FIG. 4A is a side perspective of a clamp used in a ground device.

FIG. 4B is a rear perspective of a clamp used in a ground device.

FIG. 4C is the ground device of FIG. 3A with a rubberized securing ring attached to the handle.

FIG. 5 is a flow chart highlighting an example method of using a ground device by a utility worker when replacing a distribution transformer.

FIG. 6 is a block diagram of an example implementation of a ground device where the consumer power load is back feeding a power-grid-to-residential power delivery system using a generator.

FIG. 7 is a depiction of the ground device in a configuration where the clamps are unable to touch each other without an outside force.

### DETAILED DESCRIPTION

Back feeding, in general, can be a wanted or an unwanted transfer of power from a consumer device to a commercial power grid. An example of unwanted back feed is a consumer device (e.g., a generator) transferring power into the power grid when the power grid is de-energized. An example of wanted back feed is when a solar panel system transfers excessive power into the power grid while the commercial grid is energized. The same wanted example of a solar panel could become unwanted when a lineman is working on replacing a transformer on a deenergized grid.

A goal of the present disclosure is to protect a utility worker from unwanted back feed while the utility worker is performing an operation on the commercial power grid. For the purposes of this specification, unless the context clearly dictates otherwise, “back feed” means when a consumer device transfers power into a commercial grid that is at least partially de-energized. For example, back feeding could be where a consumer is using a generator during a power outage to power the consumer's home and inadvertently transfers electricity to a commercial grid.

Consumers or unlicensed tradespeople often neglect precautions to prevent back feeding into a de-energized grid without knowledge that this back feed is or could be occurring. For example, due to a natural disaster causing a power outage, a consumer may improperly configure a home or business generator in such a way as to cause power to back feed into the commercial grid. A shortcut the consumer could take is, instead of disconnecting the homes electrical circuit from the grid power before attaching a generator to the homes electrical circuit or powering on the generator, the homeowner runs the generator connected to a house's electrical circuit connected to the power grid thus back feeding power into the commercial grid. In other examples, alternative power sources with normally desired back feed such as a solar panel array or battery system could undesirably back feed electricity into the commercial grid with the grid is deenergized.

The above-mentioned improper installation or usage of the alternative power source causes potential danger to the line worker. A line worker working to restore power would likely check whether a line is deenergized at the time of disconnecting the secondary lines from the distribution transformer. Throughout the distribution transformer replacement operation, the same line worker might incorrectly assume the disconnected deenergized grid's power line remains deenergized. Meanwhile, the homeowner suddenly turns on their improperly connected device or negligently operates the device without flipping an installed switch disconnecting the home from the power grid before usage. A secondary line becomes live during the line worker's transformer operations. Without knowledge of this change or time to respond, the line worker could get electrocuted.

Described herein are ground devices that address these back feeding problems, methods of using the ground devices, and systems including their use. These have several benefits. A first is lifesaving, preventing back feed from electrocuting a utility worker while the line worker replaces a distribution transformer in a power-grid-to-residential power delivery system. The distribution transformer may have an electrical connection to the consumer and thus have the possibility to be back fed by the consumer. A second is the use of the example ground devices may cause a fault in the back feeding device. For example, when the back feed device is a generator, the ground device may cause a ground fault within the generator thus causing the generator to stop producing power and as a result, stop back feeding into the power-grid-to-residential power delivery system. A third is the regular use of the ground devices, methods and solutions will bring increased awareness to the problem of back feeding. A fourth is preventing the inadvertent grounding that could result in death if using ground devices on the market today that were designed for other purposes. A fifth is a design that makes it hard to accidentally touch energized jumper cable clamps. A sixth is a design that is easier to handle than other grounding solutions designed for other purposes.

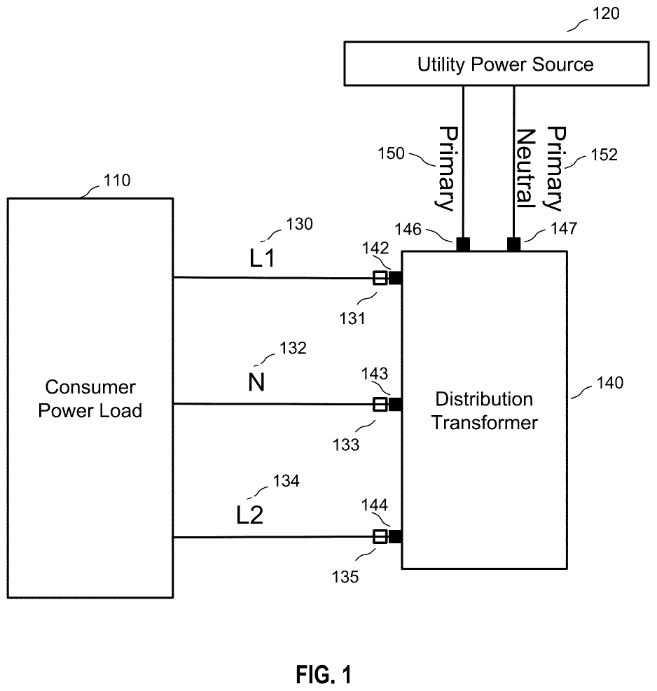

FIG. 1 depicts an overview of a typical power-grid-to-residential power delivery system in normal operation. The distribution transformer 140 steps down the power from utility power source 120 before transferring power to consumer power load 110. Utility power source 120 is electrical connected to distribution transformer 140 by primary line 150 (which in reality may be many lines) and primary neutral 152. The distribution transformer 140 may have terminals denoted as black squares for the primary 146 and primary neutral 147 that connect to primary line 150 and primary neutral 152, respectively.

Consumer power load 110 is electrically connected to distribution transformer 140 via power line L1 130, power line L2 134, and neutral line N 132. Powered lines, such as L1 130 and L2 134, and neutral lines, such as N 132, that provide electricity to a consumer power load 110 may be collectively referred to as secondaries, secondary lines, secondary wires, or triplex cable. As used herein, a “power source” or “power load” refers to where power can be drawn from such as a power line from an energized power grid. The power grid can get its energy from any source such as a power plant (e.g., nuclear, gas, generator). For convenience of understanding, a “power source” or “power load” will be referred to regardless of whether the “power source” is energized or the “power load” is present. While “consumer” and “residence” are used throughout this specification, it is understood that the examples herein could also apply in some commercial settings. The consumer side is generally downstream of the point of delivery while the utility side is generally upstream of the point of delivery. Consumer power load 110 is a reference numeral of convenience to include the power able to be drawn, if any, from the consumer or business through the secondary lines.

The distribution transformer 140 has secondary terminals 142, 143, 144 on its body denoted as black squares that connect to line L1 130, neutral line N 132, and line L2 134, respectively. L1, N, and L2 may connect indirectly to the terminals respectively through wire lugs 131, 133 and 135 or other types of fasteners/connectors denoted by white squares with black outlines. In this context, a “lug” is a generic term for the secondary wire connectors that are separatable from the terminals. These can be cable lugs, bolt connectors, screw connectors, crimp connectors or otherwise that are conductive and capable of attachment to the wire when the wire is disconnected to the terminal. The terminals of a transformer may have other names such as bushings. Other components of terminals of distribution transformer 140 may be omitted from FIG. 1. The distribution transformer 140 may be mounted on a utility pole or underground.

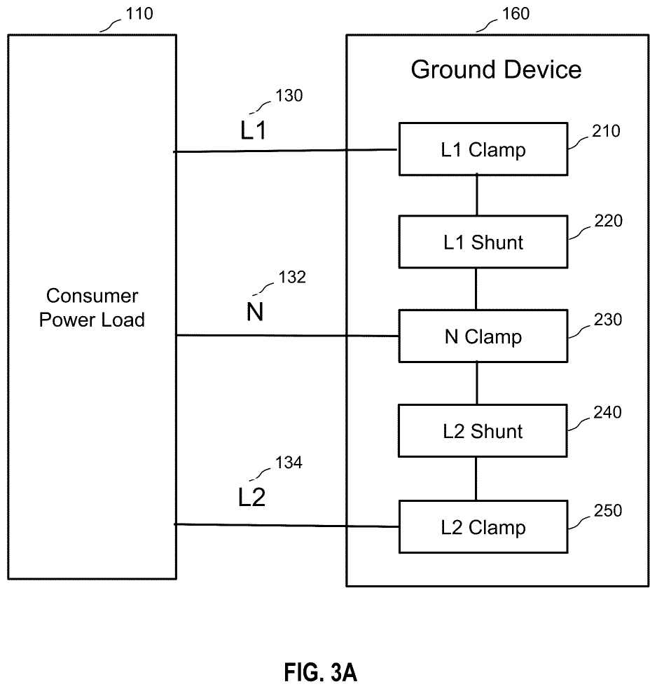

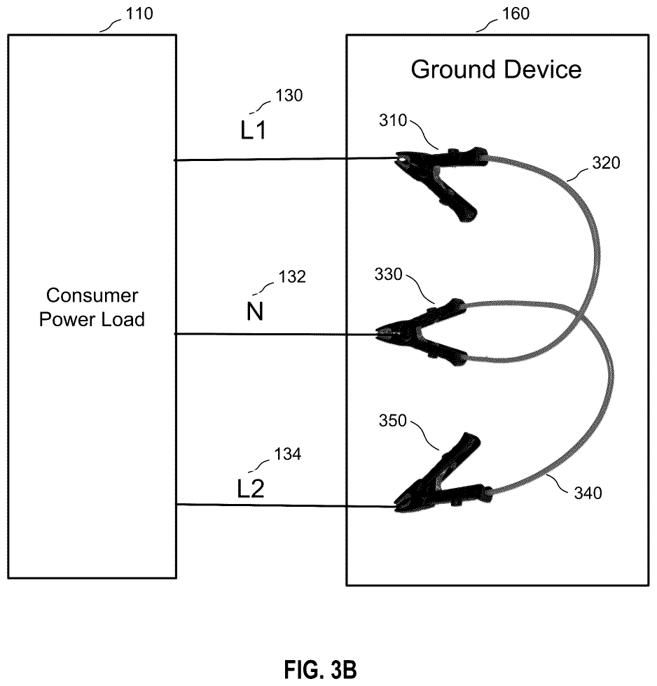

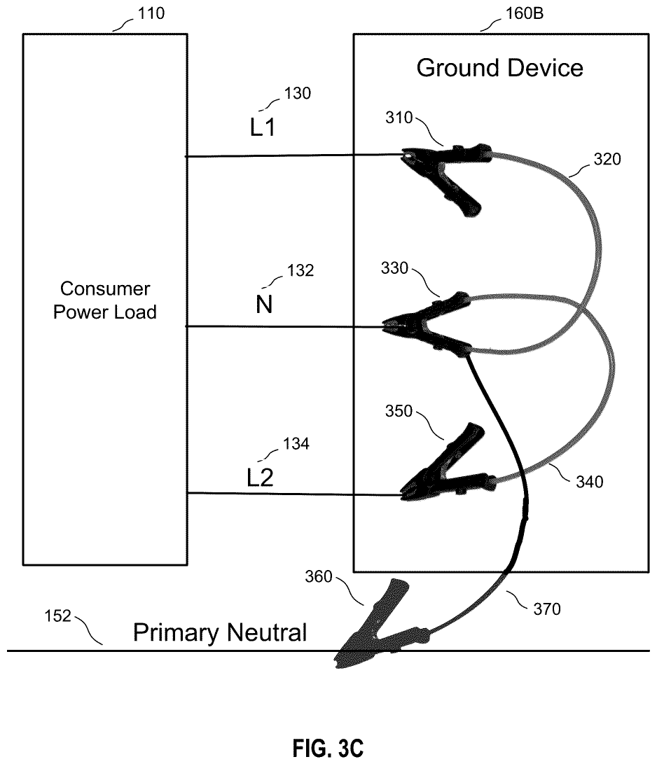

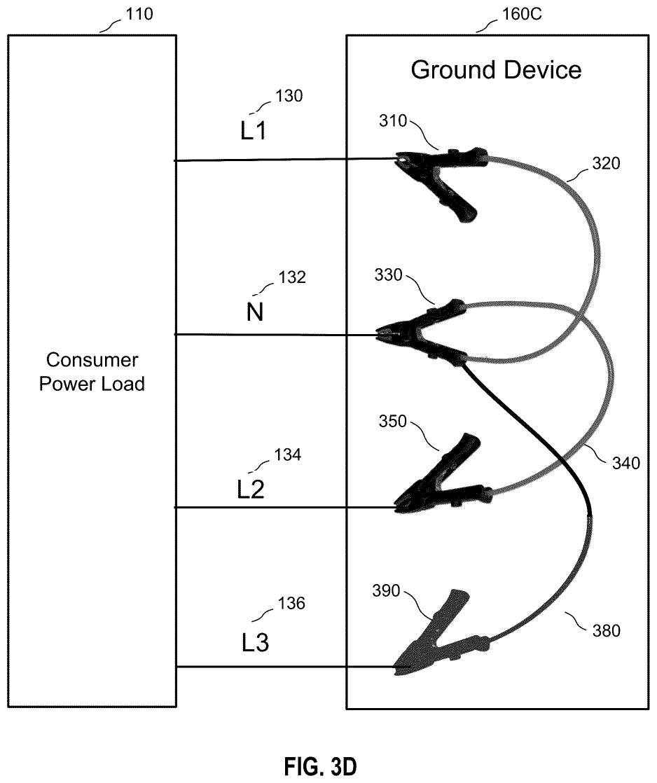

Although L1 130, N 132 and L2 134 are illustrated in simple example, any number of conducting lines, wires, or cables may be connected between utility power source 120 and distribution transformer 140. For example, a 4-unit property may have 4 times the number of secondary wires for a given transformer. The connections between the utility power source 120 and distribution transformer 140 may be adapted, if needed, for the changing conducting lines, wires, or cables. FIG. 3C is a second example of a ground device of FIG. 3B with an additional clamp and shunt used for contact with the primary neutral. FIG. 3D depicts an example where a new line L3 may be added (or this could easily be an additional neutral line) and clamp connected to a ground cable may be added. For another example, lines may be removed, such as L2 134. FIG. 3B is a diagram of the example device of FIG. 3A where the ground device is visualized with graphics of the clamps and shunts. In FIGS. 3C and 3D, the 4^{th} clamp extends from the central clamp, which here is the neutral clamp. In this way, the diversion of electricity from the shunt has the shortest path to the neutral clamp. Other arrangements are possible.

Using power industry terminology, L1 130 may be referred to as an “A line,” and L2 134 may be referred to as a “B line.” Terminals 142, 143, 144, 146, and 147 are typically referred to as X1, X2, X3, H1, and H2, respectively. In the United States of America (U.S.A.), L1 and L2 may be 120 volts AC RMS (root mean square). L1 and L2 may be out of phase to create 240-volt AC RMS between L1 and L2. For the purpose of this spec, the terms “utility worker,” “line worker” and “worker” may be used interchangeably.

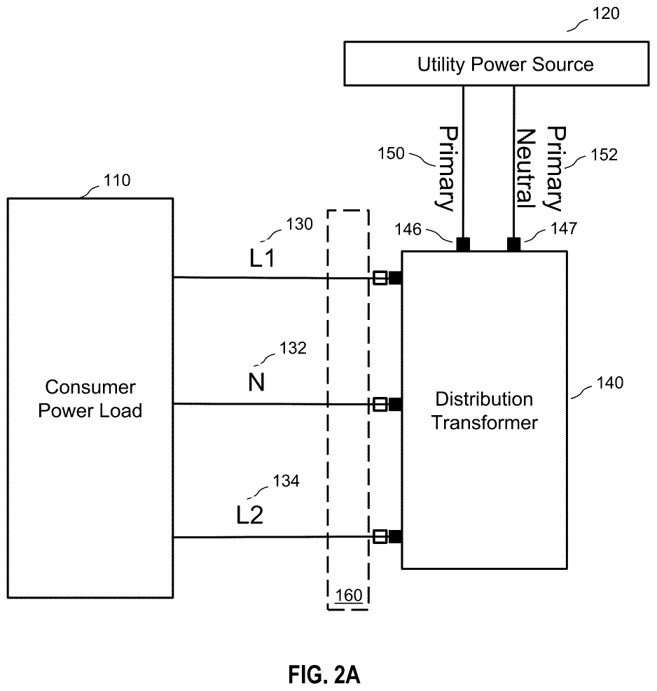

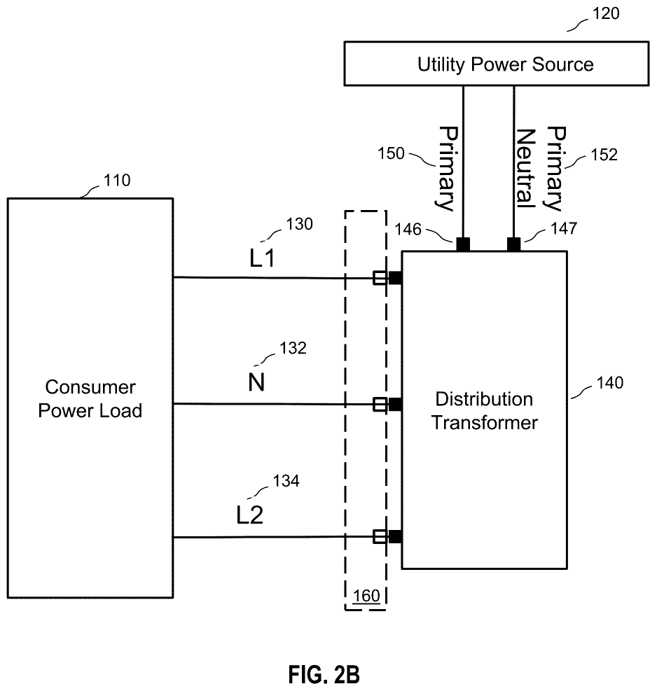

Applicant's example ground devices that can be used with the system of FIG. 1 will be described in more detail. FIGS. 2A and 2B depict example connection locations of ground device 160. FIG. 2A is a block diagram of an example connection location of ground device 160. Consumer power load 110 may be electrically connected to ground device 160 via direction connection with lines L1 130, N 132, and L2 134. The location of ground device 160 in FIG. 2 A illustrates the approximate connection location, along and near the ends of the secondary wires that connect into the transformer. FIG. 2B is a similar diagram but shows an alternative connection location of ground device 160 at the lugs at the end of the secondary cables. For example, the secondary wires may be connected to detachable lugs 131, 133, 135 which the utility worker can disconnect from and connect to the secondary terminals 142, 143, 144 during the transformer replacement operation. FIG. 2B depicts that the ground device can be connected to the lugs instead of the wires.

FIG. 3A depicts the example ground device 160 in more detail as it is connected to L1, L2 and N. Example ground device 160 includes three individual clamping mechanisms to connect to the respective lines L1 130, N 132, and L2 134 electrically connected through shunts 220 and 240. In particular, L1 clamp 210, N clamp 230, L2 clamp 250 may be clamped to lines L1 130, N 132, and L2 134, respectively, by the respective clamping mechanism of the clamps L1 clamp 210, N clamp 230, L2 clamp 250. The discussion of FIGS. 3A and 3B include one example of a possible clamp implementation. The clamps of ground device 160 that connect to lines L1 130, N 132, and L2 134 may be replaced with another physically attachable electrical component that will allow an electrical connection be made and maintained between the ground device 160 and lines L1 130, N 132, and L2 134, provided the objectives of this specification are met.

Clamps that attach to powered lines may be referred to as “power clamp(s),” and clamps that attach to neutral and/or ground may be referred to as “neutral clamp(s)” or “ground clamp(s).” For example, L1 clamp 210 and L2 clamp 250 may be referred to as power clamps, while N clamp 230 may be referred to as a neutral clamp. All of these clamp types can generically be referred to as clamps. The same physical clamp design may be used for each of power clamps, neutral clamps, or ground clamps, or the clamps may be adapted to each of these scenarios with features such as color coding and/or clamp-type specific instructions/reminders (e.g., “clamp neutral line before clamping power line). The clamps have a method of securing to the surface to be clamped, electrically and physically, while being operable by a utility worker. In this case, a “jumper cable” type hand clamp can work to reversibly fasten to the secondary lines or the lugs, and it is hand operable. The use of the clamps during the transformer replacement enhances the manipulability of the secondary wires by attaching effectively a handle used to maneuver the wire in view of the bulky insulative gloves that the utility worker is wearing.

The location of the clamps may make some clamps more suitable for a specific purpose. For example, a ground device configuration having the neutral clamp or grounding clamp as the central clamp or directly connected to the central clamp reduces the opportunity for electrocuting the utility worker as the electricity from a clamped discharging secondary line would only need to travel through one additional clamp (e.g., neutral clamp) instead of two additional clamps (e.g., second power clamp and neutral clamp).

The L1 clamp 210 and N clamp 230 electrically connect via L1 shunt 220. In an example, the L1 shunt 220 may be a conductor that provides a low impedance electrical path between L1 clamp 210 and N clamp 230. Similar to L1 shunt 220, L2 shunt 240 electrically connects L2 clamp 250 and N clamp 230. L1 shunt 220 may be a wire, cable, or other suitable electrical conductor. In another example, L1 shunt 220 may be externally electrically insulated, electrical exposed, or combinations thereof. The L2 shunt 240 may be the same or similar to L1 shunt 220. An example of a shunt is AWG Welding Cable Class K 600V Rated with a copper conductor. Examples of cable jackets are Thermoplastic High Heat-Resistant Nylon (THHN) (e.g., PVC plus a nylon layer).

In the example illustrated in FIG. 3A, N clamp 230 includes two connections. In particular, N clamp 230 includes a connection to L1 shunt 220 and L2 shunt 240. When multiple connections are needed, while other configurations are possible, it may be beneficial to have the multiple connections connected to a neutral line, such as N 132, since multiple connections may increase the number of exposed conductors and it may be beneficial having these exposed conductors at a low voltage potential point, such as neutral.

Instead of discharging the back feed only to the primary neutral as a worker may do if the worker is working upstream of the transformer, the discharge is shunted to the N secondary line. This has the benefit of not being reliant on the primary neutral being properly grounded. It also has the benefit of not drawing current across the pole and the transformer while the line worker is engaged with the replacement operations. The embodiment of FIG. 3C connects to the N line, and as a secondary discharge path, can discharge to the primary neutral.

The L1 shunt 220 and L2 shunt 240 may be attached to the respective clamp by any method that provides the desired electrical and mechanical properties. For example, a clamp may have a threaded stud, and a nut may be used to attach a shunt to the clamp. In another example, a shunt may be soldered to a clamp.

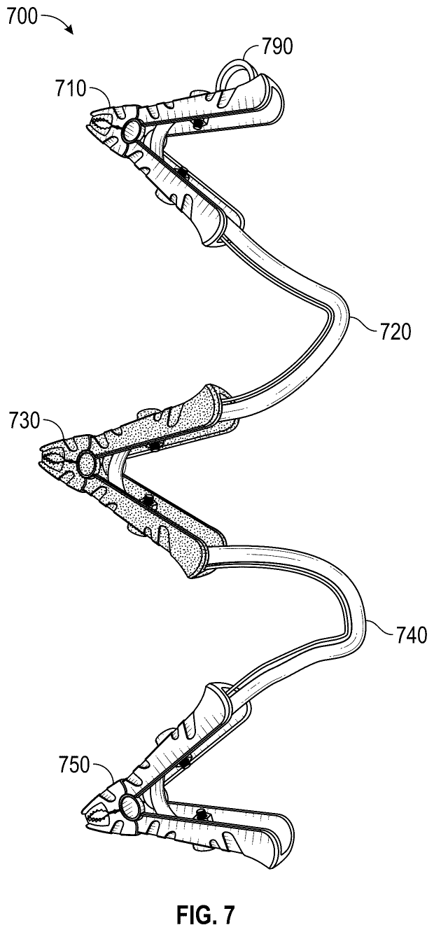

The shunt lengths between clamps are long enough to allow the utility workers to perform the necessary operations using the electrical connection locations, but not too long that the ground device would get caught in unrelated equipment or would accidentally discharge by touching the wrong grounded surface and electrocuting the line worker that is in close proximity to conductive metal. In one example configuration shown in FIG. 7, the shunt lengths and stiffnesses are designed to prevent any two clamps from accidentally touching each other. An external force would have to be applied to force two clamps together as a safety feature to prevent accidental discharge due to accidental contact of two clamps. These clamps are still operable in view of the lack of dexterity of a utility worker wearing bulky insulative work gloves. Ranges provided herein are understood to be exemplary only, and other values outside of the listed ranges may be included that meet the goals of this specification. Shunts can be coated with an insulative material to prevent discharge. Additionally, the shunts can be engineered to have a natural pre-orientation (e.g., a bend) designed to keep the clamps separated without an external force. One such way to do this is through guidewires attached to the shunts like the ones used in FIG. 7.

FIGS. 3C and 3D show additional example ground device configurations with four clamps. In FIGS. 3C and 3D, ground devices 160B and 160C each have an additional shunt 380, 390 respectively extending from the neutral clamp 330 to an extra neutral clamp 360 and power clamp 390. Additional clamps to support additional lines may be added by electrically connecting another clamp though another shunt to N clamp 330. This may be repeated until the desired number of lines is supported. Additionally, lines may be removed by removing the line clamp and the respective shunt. For example, if L2 clamp 350 is desired to be removed, L2 clamp 350 and L2 shunt 340 may be removed from the ground device 160B/C.

By maintaining electrical contact with the secondary wires, back feed on the secondary wires can be safely discharged for the duration of the entire transformer replacement operation. This provides greater safety to the utility worker and can save multiple lives every year if used at scale. In the 4-unit example mentioned above, each with its own L1 L2 N from the transformer, it is possible to use multiple 3-clamp ground devices for each unit, or one 12+-clamp ground device for the unit. It is also conceivable to use only one neutral from one unit connected to power clamps for all 4 units to reduce the number of clamps as 12 clamps can start to get a unwieldy, but this is unlikely to cause the dead fault in the back feed power source unless the line worker guessed correctly which N to use.

Similar to the examples of FIGS. 3B and 3C, a fourth clamp and corresponding shunt may be added to provide redundant grounds to primary ground and earth ground. Primary ground may be the ground on the primary side of the distribution transformer that is typically electrically connected to a utility power generation station. A utility pole typically has an earth ground cable routed down the utility power and onto a grounding stake. Typically, there is an electrical junction near the distribution transformer that joins the earth ground cable, primary ground, and a case connection of a distribution transformer. By having redundant grounds, in the situation where the consumer power load 110 is back feeding L1 130 and/or L2 134, and floating N 132, the ground device may use the redundant ground to divert the back feed away from the utility worker. Also, the electrical junction is typically physically close to the distribution transformer and may be easily accessed by the utility worker with the fourth clamp. Additionally, the attachment to the redundant ground while also connected to the secondary lines may help to mechanically separate the secondary lines away from the utility worker until the utility worker is ready to reattach the secondary lines to the new distribution transformer.

Furthermore, this redundant ground has an advantage over a separate ground wire of high voltage line ground devices installed by the utility worker to earth ground. The separate lengthy ground wire may cause a hazard to the utility workers. For example, the utility worker may become entangled in the ground wire, or the ground wire may electrocute the utility worker that is electrically connected with the metal when on the utility pole. The separate ground wire may also become entangled in the ropes used to hoist equipment and tools to the utility worker on a utility pole, or to lower equipment and tools to another utility worker on the ground. Furthermore, installing a separate ground cable would take longer to perform the distribution transformer replacement. A separate ground stake would take a significant amount of effort to drive the stake into the earth far enough to make an acceptable earth ground. Removing this stake at the end of the distribution transformer replacement would take additional effort.

A potential advantage of the architecture of ground device 160, is that even if the consumer power load 110 back feeds with the polarity reversed, the device may still protect the utility worker. For example, if the consumer power load 110 back feeds with the L1 of a generator attached to N 130 and a neutral of a generator attached to L1 130, the ground device 160 may still protect the utility worker by creating a low impedance path between line L1 130 and N 132 thus diverting the electrical current away from the utility worker. In addition, the overload protection of the generator may be triggered which would stop further back feed.

Although a typical electrical protection device is designed with the goal of maintaining the integrity of an electrical system, the ground devices discussed herein may first try to cause a fault in a back feeding device by diverting electricity from a power line to a neutral line. Should the back feeding device not stop back feeding, the ground devices may be designed to maintain the current levels such that the back feeding source fails before the ground device. It may be more desirable to damage equipment, lines, and cables than to have the ground device fail to protect the utility worker.

FIG. 2B is an example of a different mounting location, where the secondary lines are grounded by connecting to the clamps of the ground device to the consumer-side lugs on the distribution transformer.

FIG. 3A is a block diagram of another example implementation of a ground device. Consumer power load 110 may be electrically connected to ground device 160 via lines L1 130, N 132, and L2 134. Ground device 160 may include L1 clamp 310, N clamp 330, and L2 clamp 350 that clamp to lines L1 130, N 132, and L2 134, respectively. L1 clamp 210, N clamp 230, and L2 clamp may include L1 clamp 310, N clamp 330, and L2 clamp, respectively.

Shunt 320 may electrically connect L1 clamp 310 and N clamp 330. Likewise, shunt 340 may electrically connect L2 clamp 350 and N clamp 330. L1 shunt 220 and L2 shunt 240 may include shunt 320 and shunt 340, respectively. Similar to the methods described regarding ground device 160, clamps may be added or removed to ground device 160 (see, e.g., FIG. 3C as described further below).

Clamp 330 by having shunts 320, 340 attached at opposite handles. This configuration tends to naturally push clamps 310, 350 away from each other which can help to prevent the clamps 310, 350 from coming in contact with each other. In addition to providing electrical isolation, this configuration may be easier for the utility worker to grasp when installing ground device 160.

The components of the ground device 160 may be selected and configured such that a failure in the power lines may occur before a failure of the ground device 160. Additionally or alternatively, the components may be sized based on expected electrical characteristics, such as maximum voltage and/or current, and may optionally include a safety margin based on the application of the ground device 160.

Components of ground device 160 may have redundancy to mitigate device failure from a single failed component. For example, additional wires may be configured with a termination point separate from the original wire termination. For another example, multiple clamps for each line may be installed.

Should a ground device protect against a back feed event, circumstances near the distribution transformer worksite may occur to notify the utility worker of the back feed event. For example, the worker may notice an arc flash from the ground device diverting electrical current or hear the back feed. Also, jaws of the clamps may show burns from the arc flash. Additional components may be added to a ground device to inform the utility worker that a back feed event is occurring or has occurred such as a current detection sensor or a sound-based alarm.

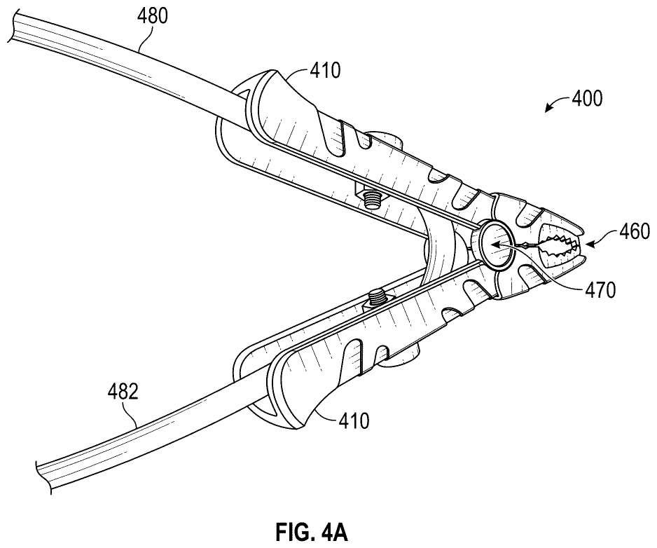

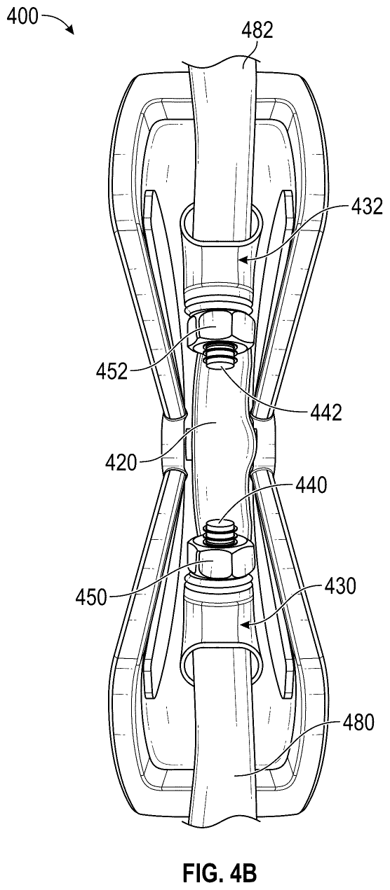

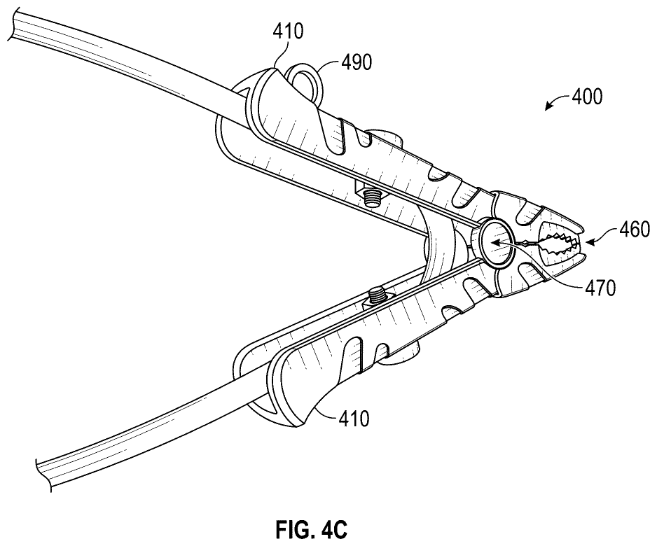

The clamp construction is designed to make a secure clamp that protects the line worker and can be repeatably used for multiple transformer replacement operations. FIG. 4A is a side perspective of an example clamp used in a ground device. To make an electrical connection between clamp 400 and the connection point, a utility worker applies a compression force between handles 410 causing jaws 460 to open. The electrically conductive jaws 460 are placed over the connection point and then released. The jaws can be made of a variety of low resistance materials, e.g., copper or aluminum. The clamp itself is constructed of a strong material such as steel. The clamp can be coated with an electrically conductive material like copper to increase its conductivity. Once the compression force on handles 410 is released by the utility worker, spring 470 causes the jaws 460 to close thus making a secure electrical connection between the clamp and the line, neutral, or ground. Spring 470 may be a heavy-duty tension spring forcing the clamp to remain in the closed position to aid in retaining the clamp on the respective line, neutral, or ground. Handles 410 may include insulators, insulative layers, insulative coatings as another way to protect the line worker from getting electrocuted. For example, handles shown use a Polyvinyl Chloride (PVC) coating for electrical insulation.

FIG. 4B is a rear perspective of an example clamp used in a ground device. In clamp 400, shunts 480, 482 are electrically connected to the jaws 460 of FIG. 4A. Any method may be used to secure shunts 480, 482 to clamp 400 so long as the connections provide the electrical connective and stress relief required to operate as a ground device. In an example, shunts 480, 482 have lugs 430, 432, respectively, crimped on. Clamp 400 may include studs 440, 442. Lugs 430, 432 may be threaded through studs 440, 442, respectively. Then the lugs 430, 432 may have nuts 450, 452 tightened, respectively, to secure the lugs 430, 432 to handle 410. Additional components or compounds may be added to studs 440, 442 and nuts 450, 452 to retain lugs 430, 432 to handles 410. For example, a locking washer may be installed between lugs 430, 432 and nuts 450, 452 to retain lugs 430, 432 to handles 410.

Although clamp 400 is illustrated with the two shunts 480, 482, any number of shunts may be attached to clamp 400. For example, for an end clamp that is only physically connected to one other clamp, shunt 480 may be attached and shunt 482 may be omitted (or vice versa). This configuration may be illustrated by L2 clamp 350. For another example, additional studs may be added to clamp 400 to accommodate additional shunts. In another example, a 3-clamp device has two shunts coming out of each clamp so that each clamp is connected to two other clamps.

Before lugs 430, 432 are attached to shunts 480, 482, respectively, lugs 430, 432 may have a heat shrink layer applied to select areas. For example, the connection point between the lugs 430, 432 and shunts 480, 482 may have heat shrink layer applied to provide additional insulation to the utility worker.

A braided strap 420 is attached to the studs 440, 442 to electrical connect shunts 480, 482. Braided strap 420 is electrically conductive, such as a braided copper bonding strap. In another example, only one shunt, such as shunt 480, may be present. After assembly of clamp 400, additional insulative material may be placed on braided strap 420, studs 440, 442, and nuts 450, 452 to further protect the utility worker from electrical shock.

As shown in FIG. 4C, clamp 400 may include an insulated ring 490 to be used as a mechanical connection point to raise and lower a ground cable to and from a utility working on a utility pole. In an example, a location on the opposite handle from the wire may be used to attach a ring. In an example ground device, the device has 3 clamps wherein 1 clamp has two shunts and the other two clamps each have one shunt. The insulated ring 490 should be physically and electrically isolated from the shunts, braided cable, or other electrical conduits to prevent utility worker exposure to the high potential current.

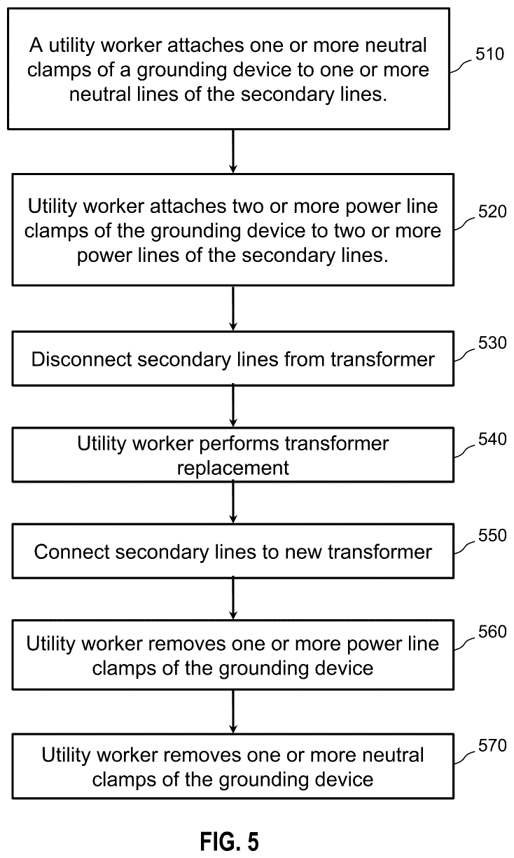

FIG. 5 is a method of using a ground device by a utility worker when replacing a distribution transformer. The distribution transformer may be mounted on a utility pole or underground. Before beginning step 510, the ground device may be inspected and/or tested. For example, the ground device may be inspected for mechanical damage. For another example, the electrical characteristics of the ground device may be tested. Additionally, before beginning step 510, pre-transformer replacement procedure may be performed. For example, the primary wire of the distribution transformer may be disconnected, and if a transformer fuse is intact, the fuse may be opened to disrupt electrical current to the primary of the distribution transformer.

Using the example of FIG. 2B, the termination of secondary lines may be into a separate device used to attach the secondary wires to the transformer's secondary terminals. For example, when the secondary lines have flag bolts crimped on the end of the lines, a clamp may be attached to the flag (or another separate device such as a lug). Alternatively, using the example of FIG. 2A, a clamp may be attached to a bare piece of the line so long as the bare piece of the line is large enough to accept the ground device clamp. When the secondary lines have a one bolt lug where the lines have the ending insulation stripped away, the clamp from the ground device may be attached to the bare line.

At step 510, a utility worker attaches one or more neutral clamps of a ground device to one or more neutral lines of the secondary lines. For example, N clamp 330 may be clamped to neutral line N 132. The utility worker may test for electricity to not be present on any of the power lines or neutrals before starting the distribution transformer replacement. For example, the neutral clamp may be connected to N 132 and not an X2 lug of the distribution transformer. The neutral clamp(s) may be positioned such that the neutral lines may be disconnected and connected to a distribution transformer without losing the connection to the lines. Additionally, a redundant ground may also be attached to a primary neutral.

At step 520, the utility worker attaches two or more power line clamps of the ground device to two or more power lines of the secondary lines. For example, L1 clamp 310 are clamped to line L1 130, and L2 clamp 350 are clamped to line L2 134. It is noted that the power line clamps may be attached to the secondary line wires or to the lugs of the secondary lines. For example, the power clamps are connected to lines L1 130 and L2 134, and not to an X1 lug or X3 lug of the distribution transformer. The power clamps may be positioned such that the powered lines may be disconnected and connected to a distribution transformer without losing the connection to the lines.

The electrical connection of the ground device to the power lines and neutrals may be verified. For example, the electrical connection between lines L1 130, N 132, and L2 134 may be tested. To verify a connection, the lines L1 130, N 132, and L2 134 may first be tested for the presence of voltage. When voltage is not present, electrical continuity between lines L1 130, N 132, and L2 134 may be verified. The device that verifies electrical continuity may be able to handle a voltage spike for the situation when back feed is started while verifying continuity. Step 530 may not be performed until the electrical connection of the ground device to the power lines, neutrals, and grounds are verified.

A utility worker may clean a surface before attaching a clamp. For example, a utility worker may use a lineman's pliers to scrape off oxidation and other matter on the lines that could cause a poor electrical connection. This cleaning can occur before clamping any of the clamps, including clamping in steps 510 and 520.

At step 530, the secondary lines are removed from the distribution transformer. The ground device may remain connected to the secondary lines. In an example, L1 130, L2 134, and N 132 may be removed from the distribution transformer.

At step 540, the utility worker performs distribution transformer replacement. It is noted that the ground device may remain attached to the secondary wires throughout this procedure to help to protect the utility worker from spontaneous back feed. The utility worker may remove the remaining lines, wires, and cables connected to the distribution transformer, such as removing the primary voltage line (H1), primary ground, and transformer case ground. The utility worker may remove the distribution transformer and install a new distribution transformer. The utility worker may reattach any lines, wires, and cables that were removed in this step.

At step 550, the secondary lines are connected to the new distribution transformer. For example, L1 130, L2 134, and N 132 may be connected to the new distribution transformer. The ground device may remain attached to the secondary lines.

At step 560, the utility worker removes one or more power line clamps of the ground device. For example, L1 clamp 310 and L2 clamp 350 of the ground device may be unclamped.

At step 570, the utility worker removes one or more neutral clamps of the ground device. For example, N clamp 330 of the ground device may be unclamped. If redundant grounds were previously attached, the redundant grounds may be removed.

The order of steps may be changed so long as the safety of the utility worker is maintained. For example, power clamps may be connected first followed by neutral. In another example, step order can be based on utility worker's judgement.

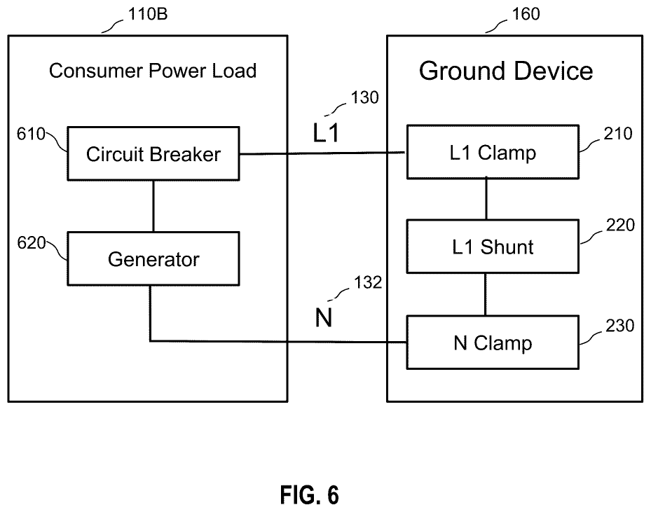

FIG. 6 is a block diagram of an example implementation of a ground device where the consumer power load is back feeding a power-grid-to-residential power delivery system using a generator. In FIG. 6, the ground device 160 includes clamps L clamp 210 and N clamp. (For simplicity, L2 clamp 250 and L2 shunt is not shown). Consumer power load 110B includes generator 620 back feeding the power-grid-to-residential power delivery system through circuit breaker 610. Generator 620 may back feed onto line L1 130.

The following discusses ground device 160 protecting a utility worker from back feed. Initially, it is assumed generator 620 is not producing electricity and circuit breaker 610 is closed (e.g., allowing electrical current to pass through). Before performing a distribution transformer replacement, the utility worker will attach ground device 160 to lines L1 130 and N 132 (and L2, not shown).

While the utility worker performs the distribution transformer replacement, generator 620 may be powered on by the consumer thus back feeding line L1 130. The initial power on L1 130 may be diverted to neutral by the low impedance of L1 shunt 220 of ground device 140D. The low impedance of L1 shunt 220 causes a spike in electrical current which in turn causes circuit breaker 610 to open (e.g., not allowing electrical current to pass). By circuit breaker 610 opening, back feeding is stopped from its source. Although line L2 134 is not shown, a similar function may be performed with line L2 134 and ground device that includes line L2 134. Similarly, other current stopping devices that are able to halt a back feed current, however they operate, could be used.

When a ground device has two power clamps and a neutral clamp, such as ground device 160, this three-clamp configuration has advantages over a hypothetical approach that uses two separate cables where each cable has two clamps for grounding secondary lines. First, separate cables require two clamps on the neutral wire. As the goal of the ground device is to remain attached to the neutral line during distribution transformer replacement, it may not be possible to attach two clamps to neutral due to the limited amount of flag or bare wire to attach a clamp to. In other words, there may not be enough physical room on the neutral wire to attach two clamps. There is typically room for one clamp. As such, the separate two cable connection may not be able to be used when the neutral wire should be connected to a ground device during distribution transformer replacement.

Second, the two separate cable approach requires 4 clamps attached to the secondary wires while the ground device with two power clamps and a neutral clamp requires three clamps. An additional clamp of the two separate cables approach may have a higher risk of failure due to the additional clamp being required to make an additional electrical connection. In other words, since the ground device with two power clamps and a neutral clamp requires one less electrical connection than a two separate cable approach, there could be a lower likelihood of a poor connection since there are fewer total connections made.

Third, the three clamps of a device ground with two power clamps and a neutral clamp takes less time to install than two separate cables with two clamps each thus allowing the distribution transformer replacement to be performed faster. Advantages of being able to perform the distribution transformer replacement faster may include decreased risk of injury to the utility worker by being engaged with a potentially dangerous electrical system for a shorter amount of time, and increasing the customer satisfaction by decreasing the time taken to replace a distribution transformer.

Fourth, distribution transformer replacement is simpler with the three or four clamps of a ground device ground with two power clamps and a neutral clamp compared to two separate cables with two clamps each. One potential reason is that clamps do not need to be doubled up on the same conductor to achieve the grounding effect. Another potential reason is that it is easier to manage a single ground device than two separate cables. For example, when the distribution transformer is pole mounted, only a single ground device would have to be hoisted to the utility worker. In contrast, when there are two separate cables, two cables would have to be hoisted to the utility worker.

Thus, a two-clamp jumper cable (even if connected to second two-clamp jumper cable as in a typical car battery jumper cable set up) requires more wires, more connections, and more time that would cause the utility worker to potentially misconnect the cables, get tangled in the cables, more install time, and more confusion than a three-clamp ground wire.

Another example embodiment is ground device 700 of FIG. 7. It has two power clamps 710, 750. It also has a color-coded neutral clamp 730 to visually differential the neutral clamp from the power clamps to make it easier to the utility worker to hook up the neutral clamp with minimal thought and to remember there is a benefit of hooking up the neutral clamp first. For example, the neutral clamp could be green to remind the line worker of the grounding nature of it. Alternatively, the neutral clamp may be white to indicate the flow of electricity a neutral line. Power claim 710 has an insulated ring 780. Shunts 720, 740 connect the power clamps 710, 750 to the neutral clamps 730. Shunts 720, 740 have guidewire within that, together with the shunt stiffness, force a pre-orientation of the clamps where the cables are more likely to stay in the attachment positions and less likely to contact each other without an external force. Instead of or in addition to color coding, other identifier means such as color coding, graphic, words, textures, and/or markings may be used.

Certain examples have been described herein, and it will be noted that different combinations of different components from different examples may be possible. For example, for a distribution transformer with more secondary lines connecting to it than L1, L2 and N, it is envisioned that ground device could scale as necessary and function similarly with additional clamps corresponding to each additional secondary line in electrical continuity with the other clamps. It is clear that certain features may be added, modified, and/or omitted without modifying the functional aspects of these examples as described.

Practitioners skilled in the art will recognize many modifications and variations. The modifications and variations include any relevant combination of the disclosed features. Descriptions herein reciting principles, aspects, and embodiments encompass both structural and functional equivalents thereof. Elements described herein as “coupled” or “communicatively coupled” have an effectual relationship realizable by a direct connection without intervening elements or indirect connection using one or more other intervening elements. Embodiments described herein as “communicating” or “in communication with” another device, module, or elements include any form of communication or link and include an effectual relationship. “Direct” connection means that the one thing is physically touching the other, as a clamp jaws on the secondary wire. “Indirect” connection means that one thing is not physically connected but is remotely connected. For example, a clamp jaws on a lug attached to the end of the secondary line is indirectly connected to the secondary line.

Even though the separate figures may have separate components, a person of skill in the art will realize that components can be mixed and matched and still be within scope of the invention. For example, the shunts 480, 482 of FIG. 4A could be used as any of the shunts in the device of FIG. 3C.

To the extent that the terms “including”, “includes,” “having”, “has”, “with”, or variants thereof are used in either the detailed description and the claims, such terms are intended to be inclusive in a similar manner to the term “comprising.”

The scope of the invention, therefore, is not intended to be limited to the exemplary embodiments and aspects that are shown and described herein. Rather, the scope and spirit of the invention is embodied by the appended claims.

The following describes various examples of the present technology that illustrate various aspects and embodiments of the invention. Generally, examples can use the described aspects in any combination. All statements herein reciting principles, aspects, and embodiments as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

It is noted that, as used herein, the singular forms “a,” “an” and “the” include plural referents unless the context clearly dictates otherwise. The use of the word “a” or “an” when used in conjunction with the term “comprising” in the claims and/or the specification may mean “one,” but it is also consistent with the meaning of “one or more,” “at least one,” and “one or more than one.” Reference throughout this specification to “one aspect,” “an aspect,” “certain aspects,” “various aspects,” or similar language means that a particular aspect, feature, structure, or characteristic described in connection with any embodiment is included in at least one embodiment of the invention. Wherever any of the phrases “for example,” “such as,” “including” and the like are used herein, the phrase “and without limitation” is understood to follow unless explicitly stated otherwise. Similarly, “an example,” “exemplary” and the like are understood to be non-limiting. The use of “(s)” on a singular word indicates that the word could be single or plural depending on the design choices of a particular embodiment or solution. The term “and/or” in a list means any single element, all elements, or any combination of the listed elements.

The terms “comprising” and “including” and “having” and “involving” (and similarly “comprises,” “includes,” “has,” and “involves”) and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, etc. Thus, for example, “a process involving steps a, b, and c” means that the process includes at least steps a, b, and c. Wherever the terms “a” or “an” are used, “one or more” or “at least one” are understood, unless such interpretation is nonsensical in context.

Appearances of the phrases “in one embodiment,” “in at least one embodiment,” “in an embodiment,” “in certain embodiments,” “in some embodiments,” and similar language throughout this specification may, but do not necessarily, all refer to the same embodiment or similar embodiments. Furthermore, aspects and embodiments of the invention described herein are merely exemplary, and should not be construed as limiting of the scope or spirit of the invention as appreciated by those of ordinary skill in the art. The disclosed invention is effectively made or used in any embodiment that includes any novel aspect described herein. All statements herein reciting aspects and embodiments of the invention are intended to encompass both structural and functional equivalents thereof. It is intended that such equivalents include both currently known equivalents and equivalents developed in the future.

### INDUSTRIAL APPLICABILITY

In addition to the goals stated above, the system, devices and methods herein can be used to save the lives of utility workers, better control the power grid, and prevent improper device installations from having downstream effects.

### Reference Numerals

110, 110b consumer power load
120 utility power source
130 L1 [line 1]
132 N [neutral]
134 L2 [line 2]
136 L3 [line 3]
131, 133, 135 secondary line lugs
140 distribution transformer
146, 147 primary terminals
160, 160B, 160C ground devices
142, 143, 144 secondary terminals
150 primary line
152 primary neutral
210 L1 clamp
220 L1 shunt
230 N clamp
240 L2 shunt
250 L2 clamp
310 L1 clamp
320 L1 shunt
330 N clamp
340 L2 shunt
350 L2 clamp
360 primary neutral clamp
370 primary neutral shunt
380 L3 shunt
390 L3 clamp
400 clamp
410 handles
420 braided strap
430, 432 lugs
440, 442 studs
450, 452 nuts
460 jaws
470 spring
480, 482 shunts
490 insulated ring
610 circuit breaker
620 generator
700 ground device
710 power clamp
720 guidewire shunt
730 neutral clamp
740 guidewire shunt
750 power clamp
790 insulated ring

What is claimed is:

1. A ground device, comprising:
at least one shunt;
three clamps that are electrically connected by the at least one shunt that defines an electrically conductive path extending to all of the clamps, the clamps sized to attach to secondary lines that connect to secondary terminals of a distribution transformer, and the clamps and conductor physically capable of carrying current flows such that electrical current applied to one clamp of higher electrical potential flows along the conductor to at least one other clamp of lower electrical potential of the three clamps,
wherein when some or all of the three clamps are attached individually to the secondary lines, back feed electrical current through one of the secondary lines is diverted to at least one of the other secondary lines.

2. The ground device of claim 1, wherein each of three clamps are hand actuated with a spring that applies tension to insulating handles of the three clamps capable of preventing or minimizing electrical shock from energized secondary lines and compression on conductive jaws of the three clamps in electrical contact with the at least one shunt.

3. The ground device of claim 1, wherein each of three clamps are able to remain secured to the respective secondary line even when that secondary line has been detached from the secondary terminals.

4. The ground device of claim 1, wherein the at least one shunt comprises a shunt between a neutral clamp and a power clamp of the three clamps, and a shunt between the neutral clamp and another power clamp of the three clamps.

5. The ground device of claim 1, wherein jaws of the three clamps are electrically connected to the at least one shunt by a braided copper bonding strap.

6. The ground device of claim 1, wherein the ground device is designed to maintain current flow until another component in electrical connection with a secondary line fails, trips, or engages over current protection.

7. The ground device of claim 1, wherein the at least one shunt is an insulated copper wire with a Thermoplastic High Heat-Resistant Nylon jacket.

8. The ground device of claim 7, wherein the at least one shunt has an ampacity of at least 100 A and class K stranding.

9. The ground device of claim 1, wherein the three clamps include two power clamps and a neutral clamp, wherein the neutral clamp is the central clamp of the three clamps.

10. The ground device of claim 1, wherein the at least one shunt has a low impedance.

11. The ground device of claim 2, wherein the insulating handles of at least one of the three clamps includes PVC insulation.

12. The ground device of claim 1,
wherein a lug is crimped on to at least one connection of the at least one shunt,
wherein a clamp of the three clamps corresponding to the connection end the shunt contains a threaded stud to receive the lug, and
wherein the at least one shunt is connected to the clamp using the threaded stud and a nut.

13. The ground device of claim 11, wherein a length, stiffness, and/or preorientation of the at least one shunt between each clamp prevents any of the three clamps from making contact with each other without an external physical force pushing them together.

14. The ground device of claim 11, wherein at least one of the three clamps has an insulated ring connected to a handle of the clamp.

15. The ground device of claim 11, further comprising a fourth clamp directly electrically connected to a central clamp of the three clamps.

16. The ground device of claim 1, wherein a central clamp of the three clamps is a neutral clamp and is color coded and/or marked to contrast with other clamps of the three clamps.

17. A method of replacing a distribution transformer, the method comprising:
clamping a neutral clamp of a ground device to a neutral secondary line such that the clamped neutral secondary lines may be removed from the distribution transformer without disconnecting the neutral clamp;
clamping two power line clamps of the ground device to two power secondary lines such that the two clamped power secondary lines may be removed from the distribution transformer without disconnecting the two power clamps;
removing the clamped neutral line and clamped power secondary lines from the distribution transformer;
replacing the distribution transformer with a new distribution transformer;
connecting the clamped secondary lines to the new distribution transformer;
removing the two power line clamps from the two or more power secondary lines; and
removing the neutral clamp from the neutral secondary line.

18. The method of claim 17, wherein clamped secondary lines are reattached to the new distribution transformer while maintaining connection with the ground device.

19. The method of claim 17, further comprising additional steps of
attaching a primary neutral line clamp of the ground device to a primary neutral line of the distribution transformer, and
removing the primary neutral line clamp from the primary neutral line of the new distribution transformer.

20. The method of claim 17, further comprising additional steps of
attaching a third power clamp of the ground device to a third power secondary line of the distribution transformer, and
removing the third power clamp from the third power secondary line of the new distribution transformer.

21. The method of claim 17, wherein before attaching any or each of the clamps, confirming that electricity is not present in any of the secondary lines.

22. The method of claim 21, wherein the step of clamping the neutral clamp further comprises
clamping a primary ground clamp separate from the neutral clamp to primary ground; and
removing one or more neutral clamps further comprises removing the primary ground clamp.

23. A system, wherein the system comprises:
a distribution transformer with secondary terminals; and
three secondary lines that connect to the secondary terminals;
a ground device with three clamps electrically connected by at least one shunt, with each clamp connected to each of the three secondary lines, wherein
when any of the three secondary lines becomes energized from back feed, the ground device discharges the back feed from the energized secondary line to at least one other of the three secondary lines.

24. The system of claim 23, wherein the system further comprises a device designed to stop the back feed upon receiving discharge current from the at least one other of the three secondary lines.

25. The system of claim 23, wherein the device designed to stop the back feed is a circuit breaker and/or a fault interrupter.
